(19) United States
(12) Patent Application Publication
(10) Pub. No.: US 2014/0052425 A1
(43) Pub. Date: Feb. 20, 2014

(54) METHOD AND APPARATUS FOR EVALUATING A MODEL OF AN INDUSTRIAL PLANT PROCESS

(71) Applicants: Sankar Selvaraj, Singapore (SG); Lakshmi Kiran Kanchi, Singapore (SG); Karthik Raja Periasamy, Singapore (SG)

(72) Inventors: Sankar Selvaraj, Singapore (SG); Lakshmi Kiran Kanchi, Singapore (SG); Karthik Raja Periasamy, Singapore (SG)

(21) Appl. No.: 13/385,592

(22) Filed: Aug. 16, 2012

(51) Int. Cl. G06G 7/48

(52) U.S. Cl. 703/6

(57) ABSTRACT

A method of evaluating a model of an industrial plant process, the method comprising the steps of: evaluating at least two out of three criteria, the three criteria consisting of: (i) a condition deviation, (ii) a quality deviation, and (iii) a priori information obtained from a fuzzy logic module; and giving an indication as to whether or not the model should be retrained.

### FIELD OF THE INVENTION

The invention relates to method and apparatus for evaluating a model of an industrial plant process, and particularly, though not exclusively, relates to evaluating a model used for monitoring and controlling the industrial plant process.

### BACKGROUND

In process industries, process models play an important role in fault monitoring and predictive modelling and controlling of plant processes, among other functions. Due to the limitations of traditional knowledge representation methods for modeling complex chemical processes, statistical models have been developed. Also, Artificial Intelligence areas of machine learning and reasoning under uncertainty have generated a variety of techniques such as decision trees, neural networks and Bayesian networks for adapting models to actual behaviour of a system based on predictive methods.

Typically, machine learning evaluation consists of dividing a data set into a training set and a test set, using the training set to learn and develop a model, and using the test set to evaluate the model's performance. However, when changes arise in actual plant processes, such as a change in product or raw material, or even a change in environmental conditions, existing models will fail, and will need to be retrained in order to remain meaningful for monitoring and predicting actual process behaviour. Techniques commonly used for retraining a model are typically windows-based techniques requiring selection of a window, or recursive techniques requiring selection of weightage to each dataset before training. Correct window and weightage selection thus determine the effectiveness of the chosen method. Currently, the selection of window and weightage is manually performed by a user. It will be appreciated that proper selection requiring substantial user experience and skill in order for models to be correctly retrained.

### SUMMARY OF THE INVENTION

A method and apparatus is provided to automatically retrain a model by evaluating the model's performance. The method and apparatus use both the historical behavior of a key parameter as well as the behavioral pattern of other key parameters in order to predict the behavior of a target parameter, which may be a quality index, for example. Any deviation between actual and predicted quality and other key parameters can be used to decide whether or not to retrain an existing model. Re-training and evaluation of the re-trained model occur online without human intervention.

By providing the method and apparatus to evaluate and retrain model in real time and online, quality monitoring of complex processes like polymer reactor quality becomes possible, enabling tighter control on the quality of the final product. Such an adaptive retraining and evaluation method and apparatus allows the user to monitor multiple grades of product being produced without the need to collect training data manually and construct different models for each grade in offline mode.

According to a first exemplary aspect, there is provided a method of evaluating a model of an industrial plant process, the method comprising the steps of evaluating at least two out of three criteria, the three criteria consisting of: (i) a condition deviation, (ii) a quality deviation, and (iii) a priori information obtained from a fuzzy logic module; and giving an indication as to whether or not the model should be retrained.

The method may further comprise the step of, prior to the evaluating, comparing a predicted model parameter with a process parameter on a first computer and outputting the condition deviation.

The method may further comprise the step of prior to the evaluating, comparing a predicted model quality with a process quality on a second computer and outputting the quality deviation.

The method may further comprise the step of automatically retraining the model when the indication is to retrain the model.

According to a second exemplary aspect, there is provided an apparatus for evaluating a model of an industrial plant process, the apparatus comprising a condition deviation checking module configured to perform a comparison of a predicted model parameter with a process parameter on a first computer and to output a condition deviation; a quality deviation checking module configured to perform a comparison of a predicted model quality with a process quality on a second computer and to output a quality deviation; and an evaluation module configured to give an indication as to whether or not the model should be retrained after evaluating at least two out of three criteria, the three criteria consisting of: (i) the condition deviation, (ii) the quality deviation, and (iii) a priori information obtained from a fuzzy logics module.

For both aspects, the predicted model parameter may be a value at a time Tₜ₊ₙ predicted by the model at a time Tₜ, and the process parameter is a value at the time Tₜ₊ₙ obtained from the process. The predicted model quality may be an output quality at a time Tₜ₊ₙ predicted by the model at a time Tₜ, and the process quality is an output quality obtained from laboratory testing of the product produced at the time Tₜ₊ₙ by the process.

### BRIEF DESCRIPTION OF THE DRAWINGS

In order that the invention may be fully understood and readily put into practical effect there shall now be described by way of non-limitative example only exemplary embodiments of the present invention, the description being with reference to the accompanying illustrative drawings.

In the drawings:

FIG. 1 is an architectural and flow diagram of an apparatus and method of evaluating and retraining a model of an industrial plant process; and

FIG. 2 is a graph of an exemplary change in process and ensuing change in quality.

### DETAILED DESCRIPTION OF THE EXEMPLARY EMBODIMENTS

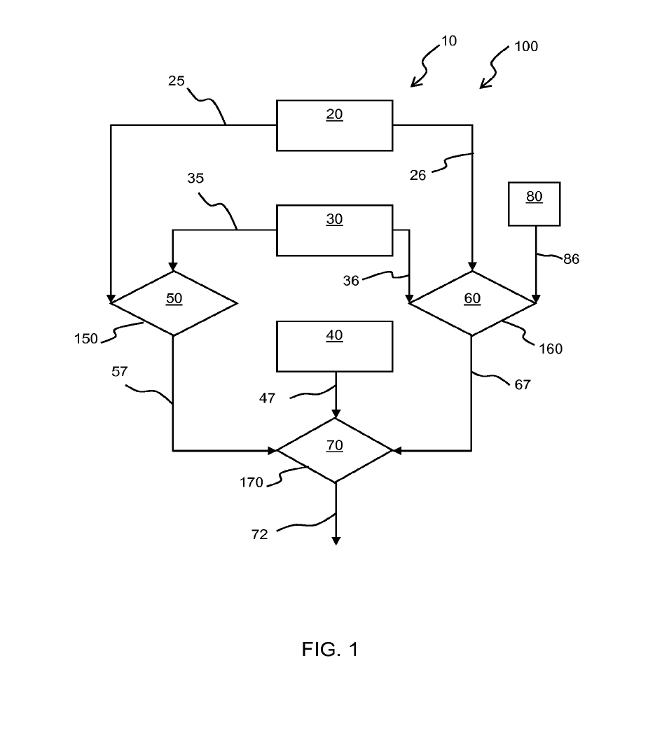

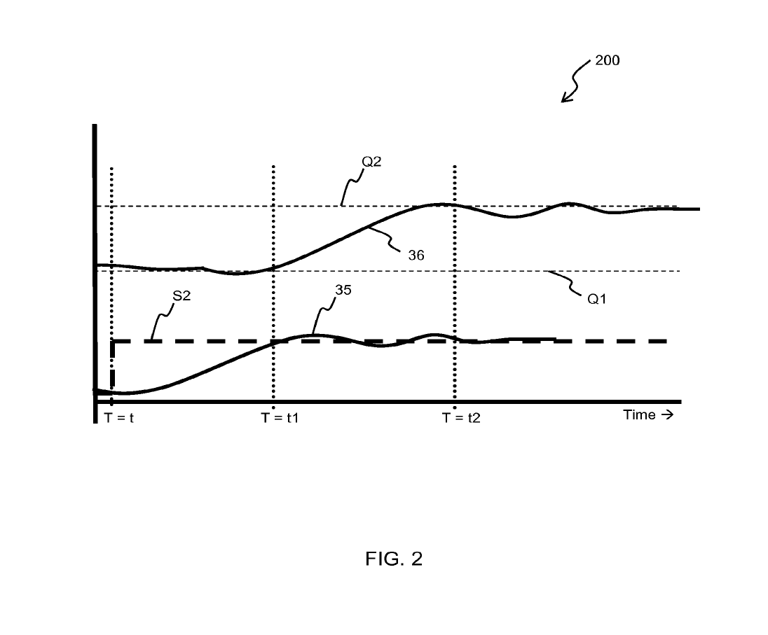

An exemplary method 100 and apparatus 10 for evaluating a model 20 of an industrial plant process 30 will be described with reference to FIGS. 1 and 2 below.

In the method 100 and apparatus 10, information obtained from an existing model 20 of an industrial plant process 30 is compared with information obtained from the process 30. The information to be compared may comprise operating conditions such as values of a predicted model parameter 25 and a process parameter 35 as well as measures of predicted model quality 26 and process quality 36 of a product produced under those operating conditions.

As shown in FIG. 1, the predicted model parameter 25 and the process parameter 35 are compared 150 in a condition deviation checking module 50 of the apparatus 10, the comparing 150 being performed by a first computer. The condition deviation checking module 50 outputs a condition deviation 57 that indicates whether and how much condition deviation 57 there is between the predicted model parameter 25 and the process parameter 35. It should be noted that the predicted model parameter 25 is a value at a time Tₜ₊ₙ predicted by the model 20 at a time Tₜ, where n is a process lag or elapsed time from the time t, while the process parameter 25 is a value at the time Tₜ₊ₙ obtained from the process 30.

Similarly, the predicted model quality 26 and the process quality 36 are compared 160 in a quality deviation checking module 60 of the apparatus 10, the comparing 160 being performed by a second computer. The second computer may be a same computer as the first computer. The quality deviation checking module 60 outputs a quality deviation 67 that indicates whether and how much quality deviation 67 there is between the predicted model quality 26 and the process quality 36. It should be noted that the predicted model quality 26 is an output quality 26 at the time Tₜ₊ₙ predicted by the model 20 at the time Tₜ, while the process quality 36 is an output quality 36 obtained from laboratory testing of the product produced at the time Tₜ₊ₙ by the process 30.

Both the condition deviation 57 and the quality deviation 67 may be determined by checking for deviation from a predetermined band or a cluster of bands.

The condition deviation 57, the quality deviation 67 and also a priori information 47 obtained from a fuzzy logic module 40 are then evaluated 170 in an evaluation module 70 of the apparatus 10 which is configured to give an indication 72 as to whether or not the model 20 should be retrained, or whether remedial action should be taken to correct a fault. The condition deviation 57, the quality deviation 67 and the a priori information 47 are thus three distinct criteria evaluated 170 by the evaluation module 70.

Preferably, all three criteria 47, 57, 67 are together evaluated to arrive at the indication 72. However, an indication 72 can be obtained so long as there are at least two (47 and 57; 47 and 67; or 57 and 67) out of the three criteria 47, 57, 67 available for evaluation 170.

For example, if the condition deviation 57 is found to be significant, the evaluation module 70 checks the quality deviation 67 to determine whether the significant condition deviation 57 is due to an intentional change in process 30 conditions or whether the process 30 conditions are faulty. Normally, it would be expected that a significant quality deviation 67 would indicate a faulty process 30 condition. However, a significant quality deviation 67 may also occur temporarily when a new, intentional set point has been made for a process parameter 35 and an intentional process change occurs but the corresponding process quality 36 is taking longer than the process change to adjust from an existing quality to a target quality aimed for by the new set point. This is illustrated by the graph 200 in FIG. 2, where at time T=t, an intended process change of a process parameter 35 to a new set point S2 is made, but output process quality 36 starts to change only from time T=t1 onwards from an existing quality Q1 to reach saturation, i.e., the target quality Q2, at time T=t2. Thus, in the time period from time T=t to time T=t1, there is no significant change in the process quality 36 although there was a change made in the process at T=t. The process parameter 35 thus reflects the change first and hence at time T=t1, the condition deviation checking module 50 would show a larger condition deviation 57 whereas the quality deviation checking module 60 would not show significant quality deviation 67 since the process quality 36 has not yet changed. In such scenarios, based on only the condition deviation 57 and the quality deviation 67, it may be difficult to come to a conclusion whether to treat the condition deviation 57 as a fault or to conclude that there is a need to retrain the model 20. Hence, the fuzzy logic module 40 aids decision-making by providing necessary insight from established standard operating procedures and/or past experience and/or knowledge previously captured, by establishing simple rules based on all these. In this way, a combination of the condition deviation 57, the a priori information 47 provided by the fuzzy logic module 40 and the quality deviation 67 would help arrive at a decision whether to or not to retrain the model.

By continually using the method 100 and apparatus 10 online, the model 20 can be automatically retrained without human intervention upon every evaluation of at least two out of the three criteria 47, 57, 67 mentioned above that results in an indication 72 to retrain the model. In this way, users can use the model 20 to monitor multiple grades of product being produced without a need to collect model training data manually and construct a different model for each grade in offline mode of product being produced.

Whilst there has been described in the foregoing description exemplary embodiments of the present invention, it will be understood by those skilled in the technology concerned that many variations in details of design, construction and/or operation may be made without departing from the present invention. For example, while the predicted model quality 26 has been described above as being output from the model 20, it should be noted that this is usually the case when the model 20 is used for quality control or when the model 20 has quality parameters within it. Alternatively, a predicted model quality 86 may be obtained from a dedicated quality estimator or quality monitoring model 80 when the model 20 is only used for monitoring the process 30 and quality is not a modelled parameter within the process model 20. Information from the quality monitoring model 80 can thus be used for enhancing the decision 72 made by the evaluation module 70.

1. A method of evaluating a model of an industrial plant process, the method comprising the steps of:
a) evaluating at least two out of three criteria, the three criteria consisting of: (i) a condition deviation, (ii) a quality deviation, and (iii) a priori information obtained from a fuzzy logic module; and
b) giving an indication as to whether or not the model should be retrained.

2. The method of claim 1, further comprising the step of, prior to the evaluating, comparing a predicted model parameter with a process parameter on a first computer and outputting the condition deviation.

3. The method of claim 2, wherein the predicted model parameter is a value at a time Tₜ₊ₙ predicted by the model at a time Tₜ, and the process parameter is a value at the time Tₜ₊ₙ obtained from the process.

4. The method of claim 1, further comprising the step of, prior to the evaluating, comparing a predicted model quality with a process quality on a second computer and outputting the quality deviation.

5. The method of claim 4, wherein the predicted model quality is an output quality at a time Tₜ₊ₙ predicted by the model at a time Tₜ, and the process quality is an output quality obtained from laboratory testing of the product produced at the time Tₜ₊ₙ by the process.

6. The method of claim 1, further comprising the step of automatically retraining the model when the indication is to retrain the model.

7. An apparatus for evaluating a model of an industrial plant process, the apparatus comprising:
a condition deviation checking module configured to perform a comparison of a predicted model parameter with a process parameter on a first computer and to output a condition deviation;
a quality deviation checking module configured to perform a comparison of a predicted model quality with a process quality on a second computer and to output a quality deviation; and
an evaluation module configured to give an indication as to whether or not the model should be retrained after evaluating at least two out of three criteria, the three criteria consisting of: (i) the condition deviation, (ii) the quality deviation, and (iii) a priori information obtained from a fuzzy logics module.

8. The apparatus of claim 7, wherein the predicted model parameter is a value at a time Tₜ₊ₙ predicted by the model at a time Tₜ, and the process parameter is a value at the time Tₜ₊ₙ obtained from the process.

9. The apparatus of claim 7, wherein the predicted model quality is an output quality at a time Tₜ₊ₙ predicted by the model at a time Tₜ, and the process quality is an output quality obtained from laboratory testing of the product produced at the time Tₜ₊ₙ by the process.
